(19) United States
(12) Patent Application Publication
(10) Pub. No.: US 2002/0077875 A1
(43) Pub. Date: Jun. 20, 2002

(54) Apparatus and management system for efficient collection of trash and the like

(76) Inventor: Ami Nadir, Karmiel (IL)

Correspondence Address: Rashida A. Karmali, Suite 2525, 230 Park Avenue, New York, NY, 10169, US

(21) Appl. No.: 09/739,319

(22) Filed: Dec. 18, 2000

(51) Int. Cl. G06F 17/60

(52) U.S. Cl. 705/8; 700/305

(57) ABSTRACT

An apparatus and electronic system for optimizing a trash pick-up schedule of a plurality of trash compactors is disclosed. The system comprises the steps of measuring the weight of trash in a trash compactor; calculating from said trash weight a targeted trash weight optimal for pick up; predicting a pick-up time based on said trash weight and said optimal trash weight; transmitting a signal to a fleet management unit; calculating a pick-up schedule for said plurality of trash compactors; generating a bill containing accounting information for said trash compactor unit; and generating a warning when said trash compactor unit malfunctions. The system permits efficient trash pick-up based on customer needs and accordingly provides a cost-effective and environmentally friendly system.

### 1. BACKGROUND OF THE INVENTION

The present invention relates to a collection system for garbage, trash, and the like which results in high efficiency, cost savings and better service. The invention employs advanced algoritluns to predict and schedule when to empty each waste-compacting container or compactor. Analysis of the nature the trash and the prediction of its weight are accomplished through methods using electronic communication and search engines intelligence. The computer system can be added onto any existing compactor fleet.

As human population expands at an exponential rate, waste processing and disposal have become major issues around the world. In particular, it has been a growing public concern and the United States government has spent a considerable amount of money for the trash removal. If unchecked, the trash builds up and causes environment damages, odor formation and severe health hazards. To prevent or at least minimize environment damages as well as to promote health, most developed countries have introduced stringent regulations to the treatment and disposal of trash. Such regulations have lead to the formation of a multibillion-dollar industry that collects trash and processes all types of waste, using in many cases, sophisticated technological solutions.

Depending on the location, areas where there are large populations of homeowners and/or businesses often have a huge volume of trash, while sparsely populated areas have a small volume of trash. It is therefore logical that the heavily populated areas should have more frequent trash collection, and the lesser populated areas should have lesser frequent trash collection. The current trash collection systems are often accomplished manually. Such systems are inefficient because in most cases the frequency of pick-upis determined at random, rather than on the rate of which trash is generated. If the trash collection does not keep up with the trash build up, the accumulated trash causes odor buildup and health hazards. There is therefore need for an advance and efficient trash pick-up system which would reduce labor and costs and encourage recycling and promote better health environment.

Trash compactors have been widely developed and used in Western Europe and North American in order to reduce waste hauling expenses. These trash compacts have a hydraulic press that steadily compresses the contents and increase the quantity of waste in the container by the factor of four. The trash compactors are then transported by a fleet of roll-off vehicles from the user's sites to the processing/disposal sites on-call or on a periodic basis. An efficient method of communication and method of doing business is needed to dispatch a fleet of trucks to compactor locations for trash pick-up

A number of systems involving trash pick-up trucks and containers have been developed over the past years. However, many of such system are operated by individuals. When more than one person is involved, trash pick-up schedual is prepared manually and usually by a fixed time period (i.e., daily or weekly). These systems cannot meet the current demand of an efficient trash pick-up. For example, many communities today have begun to build up trash at a rate and at a level that manual trash pick-up scheduling can no longer efficiently dispatch trucks to pick up trash from multiple compactors. As a result, trash builds up and causes health hazards. Additionally, today's communities require separation of garbage and trash into several groups, e.g., cans, bottles, and paper. Manual scheduling of pick-up remains an out-dated approach in trash removal and an efficient trash pick-up system is urgently called for.

### 2. SUMMARY OF THE INVENTION

The present invention describes an efficient collection system for trash, garbage, refuse and the like. The system involves placing many compactors at different user locations where trash can be collected. Each compactor comprises a hydraulic power unit that functions to compact the trash to a defined and reduced volume for efficient collection.

The present invention, comprises a comprehensive management and service system that enables operators of a fleet of roll-off vehicles to remotely monitor the status of trash compactors at user's sites, thereby allowing prompt and efficient schedualing of trash, and delivering a more efficient customer service at a lower cost. The system is a solution for operators of a fleet of roll-off vehicles, enabling a cost-effective service of trash compactors in any given geographical area, by means of land, water or air transportation.

The system employs electronic communications computerized monitoring to evaluate when the compactors reach the target weight to require collection.

The present invention comprises a Trash Compactor Management Unit (TCMU) and a Fleet Management Unit (FMU). The TCMU is a microprocessor based hydraulic subsystem computer and a two-way data communication gear which is attached directly to any trash compactor. The FMU is a PC-based computer system located at a service provider's headquarters. The FMU collects reports and processes data received from the TCMU in a service area. The TCMU and the FMU communicate with each other in both directions by electronic communications systems such as personal, public and business telephone systems or cellular telephones. The present invention also provides a well coordinated and monitored method of doing business in relation to trash collection worldwide.

### 3. BRIEF DESCRIPTION OF FIGURES

FIG. 1 depicts a basic system configuration showing the communication relationship between a central station housing a computer and database for customers, company and compactors and a truck fleet in accordance with the present invention.

FIG. 2 depicts a flow diagram showing a configuration of user compactor and a central location in accordance with the present invention, representing a bi-directional computerized trash management system.

FIG. 3 depicts a detailed flow diagram showing data processing by the central location to generate a design pick-up schedule information.

FIG. 4 depicts a block diagram showing the design pick-up scheduling starting from the status reports of a compactor received at the central office, to a pick-up schedule by the task scheduler and to the fleet management unit.

FIG. 5 represents a maintenance flowchart depicting the sequence of events involved in reporting problems and carrying out repairs in the overall system.

### 4. DETAILED DESCRIPTION OF THE INVENTION

Referring to the drawings, various embodiments of the present invention will be explained below with respect to an efficient system for collecting trash and the like.

Firstly, some explanation will be given concerning the disclosed environmental system relating to trash collection. A plurality of compactors are placed at designated areas known as waste sites where users in residential and business districts dispose or dump the trash or waste into their compactors at the designated waste sites. A key feature of the present invention is that decisions relating to trash pick-up are made according to the trash weight in each compactor. In particular, trucks will be dispatched more frequently to areas where there is a lot of trash and less frequently to areas where there is lesser trash. In order to maintain such a need based pick-up schedule, close communication between a central location and the waste sites is provided by the present invention.

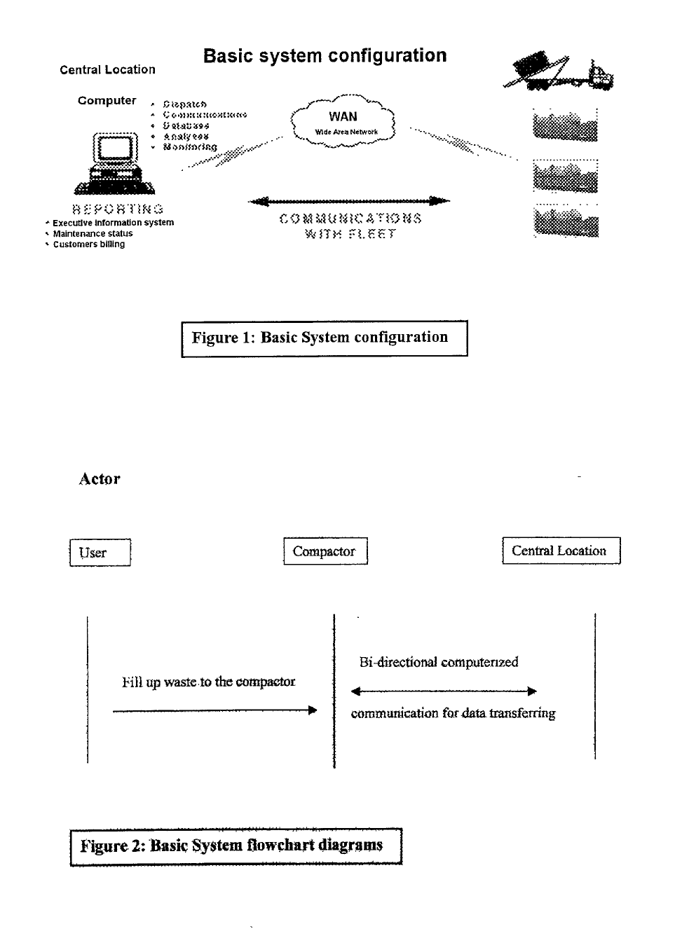

FIG. 1 shows such a basic system configuration comprising a computer located at a service providers headquarters that collects and processes data and reports received from all compactors and is also in electronic communication with the fleet. The information relating to trash weight is communicated to the central location via a computer. Thus, the present invention is directed to a data processing system and method of business in efficiently managing a collection system for trash. The disclosed data managing and processing system is the comprehensive management service system. The comprehensive management service system comprises two structural components. The first component is a trash compactor management unit, located at waste sites and the second component is a fleet management unit, located at a service provider's office.

FIG. 2 depicts the user who generates the trash, a compactor for collecting the trash and a central location which is in two-way computerized communication with the compactor.

The trash compactor management unit comprises a microprocessor based hydraulic subsystem and a two-way data communication device, associated with the trash compactor. In one embodiment, the microprocessor is directly attached to the trash compactor.

The compactor is also equipped with a weight sensor that measures the weight of the trash. The hydraulic subsystem compacts the trash after which the weight sensor measures the weight of the compacted trash. Alternatively, the weight sensor device monitors the trash weight continuously or periodically. For example, weight measurement can be measured on an hourly or daily basis. The invention is not limited to the time interval within which the weight sensor measures the trash weight.

Within the trash compactor management unit is a microprocessor that receives the information on actual trash weight from the weight sensor. The microprocessor calculates a projected time at which a predicted trash weight presumptively reaches or attains a target trash weight. The microprocessor can predict the time when the compactor reaches its target weight, at a target time.

The microprocessor of each compactor continuously calculates predicted trash weight and target time, such information is crucial for the fleet management unit to generate a pick-up schedule for all compactors. In one preferred embodiment, the target time is calculated based on the target weight reaching within 97-100% of the actual weight. In another preferred embodiment, the target time is calculated based on the target weight reaching its 97-100% of actual weight 24 hours in advance. The microprocessor is attached to and adapted to work with any kind of compactor used by the customers.

The microprocessor re-calculates the pick-up time each time trash is deposited in the compactor and/or new trash weight information is input to the microprocessor. After each compactor is picked up and emptied, when the weight goes back to zero the microprocessor re-initiates its functions by rescheduling a new pick-up time.

The compactor is designed never to overflow or be overweight in order to conform to environmental and traffic transportation rules. The trash compactor management unit accurately predicts the time of the compactor's contents' attaining the target weight, in order to avoid compactor overweight problem as well as to achieve the cost efficiencies possible by hauling only compactors at or near their target weight.

FIG. 2 depicts a flowchart showing how trash weight information is transmitted from the trash compactor management unit to the fleet management unit. The trash compactor management unit has a device and means to transmit signals relating to trash weight information to the central location (i.e., fleet management unit). After users dump trash into the compactor, the microprocessor associated with the compactor processes information relating to actual trash weight and target trash weight, and transmits the information from each compactor to the fleet management unit, including information relating to the target time for each compactor.

FIG. 1 also depicts a data communication system between compactors and the fleet management unit. Operational and maintenance events can be transmitted from each compactor to the fleet management unit. The data communication system can function with any method of communication fitted to the customer's needs, and can be chosen based on availability in the user's location and cost effectiveness. Data transmission systems are well known in the art. One example is a wide area network In a preferred embodiment, the data communication system is a two-way communication system whereby information can be transmitted from compactors to the fleet management unit and vice versa. Information can be automatically analyzed and saved in a database at the fleet management unit. Information can be displayed in various forms, on display screens or TV monitor, to fit market needs.

The fleet management unit depicted in FIG. 1 can be is a micro-computer based system that collects and processes data and status reports received from the trash compactors management units in the service area. For example, the micro-computer based system can be Mac, Windows or work stations. The computer system is not limited by the examples set forth herein and the knowledge about the use of other compatible computer systems is well known in the art. Upon receiving trash weight and target time signals from fic a trash compactor management unit, the fleet management unit stores, analyses, and monitors the data. The fleet management system can display each trash weight and target time entry for each compactor.

In another preferred embodiment, operational and maintenance information can be transmitted from each compactor to the fleet management unit. The communication system can function with any method of communication fitted to the customer's needs, and can be chosen based on availability in user's location and cost effectiveness. This information can be analyzed and saved in a database at the fleet management unit.

The fleet management unit can also retrieve the stored data from the database and process the data. The fleet management unit can create several files including: 1) a schedule of pick-up times for each trash compactor management unit; and 2) an active file on each trash compactor management unit.

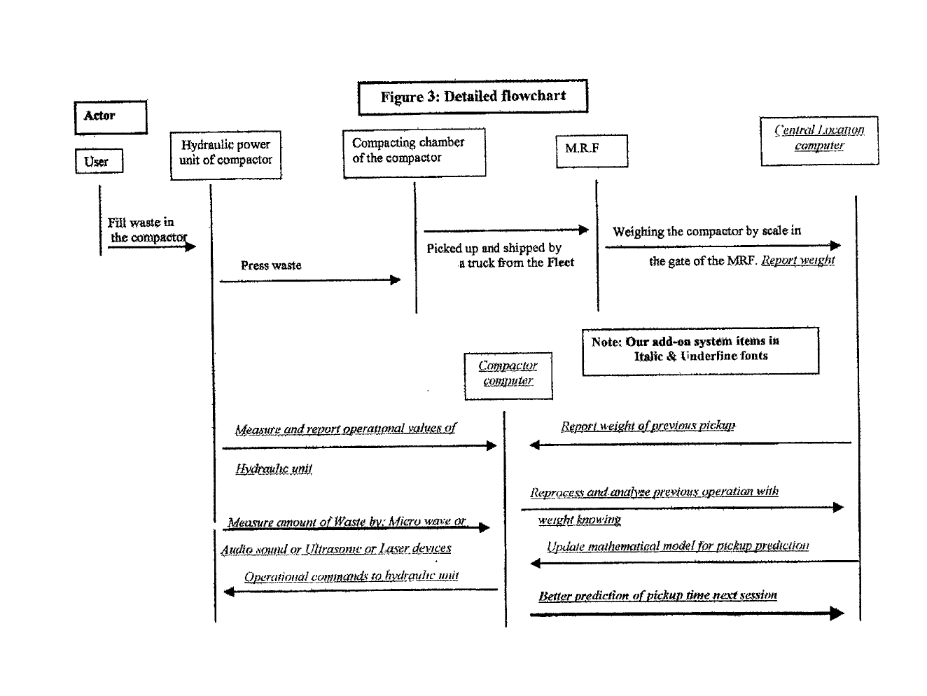

FIG. 3 is a flowchart depicting a design pick-up scheduling. When signals or status report from each compactor are received, the fleet management system updates an optimal schedule of pick-up based on the target time for each compactor in the fleet. The fleet management unit stores past and most recent data regarding target times. For example, the fleet management unit can retrieve the prior day's trash weight and pick-up schedule as well as scheduling the next day's trash pick-up. The purpose of this routine is to allocate the daily pick-up schedule and record daily trash weight on each and every compactor.

The pick-up schedule is not limited by the examples set forth herein; and pick-up schedule can be on a weekly or monthly basis.

The computer system of the fleet management unit is capable of calculating and creating a pick-up schedule based on the target times. An initial schedule can be generated in advance, and shall be subsequently updated, utilizing more recent data. As soon as a schedule for each truck is completed, information is transmitted to the truck fleet for dispatch to pick up trash accordingly.

An important advantage of the present invention relates to cost savings. The rationale for the present invention is that only those compactors close to their target weight are picked up. Accordingly, fewer hauling trips are needed and cost is greatly reduced. In addition, better service is achieved by picking up the compactor at the time it is expected to reach its target weight. Because trash is picked up before any compactor reaches its full capacity, there is virtually no trash over-spill or over-flow. There is no build up of trash that causes bad odors or attracts rats, flies, pests, or roaches. The present invention results in a more healthy and hygienic environment and imparts better living conditions for people.

Compactors are always ready to accept waste and won't overflow. The compactor are never overweight. Compactor maintenance is enhanced due to operational data communication with the central location. It is easy to combine the present invention with any kind of compactor, requiring only minor changes.

In another preferred embodiment of the invention, the fleet management unit performs billing and accounting operations from the existing customers database hauling orders. Thus, the comprehensive management and service system (shown in FIG. 4) gives the service provider an over-all picture of the service and improves the planning for resources needed. The system permits forecast of hauling requirements, optimal hauling schedules and routings, billing and collection of hauling fees.

The standard procedures and automatic operation of the compactor are automatically indicates when trash has been picked up and at what weight. The target weight for pickup of each compactor is defined and pick-up is called for only when the compactor is close to its full capacity. This is a benefit from utilizing the comprehensive management and service system of the invention. It should be noted that the cost of hauling a partially filled compactor is almost the same as that of hauling a full compactor. Because only fully loaded trash compactor are being hauled in the present system, there are considerable savings in direct hauling expenses. The system is estimated to save as much as 40% in cost of direct hauling expenses. Accordingly, the present invention improves the service quality and reliability of a trash collection system.

In another preferred embodiment of the present invention, the comprehensive management service system permits compactor maintenance. FIG. 5 depicts a flowchart showing compactor maintenance in accordance with the present invention. It is well known in the art that there are measuring parameters of the compactor in action that reveal operational problems. When a compactor malfunctions, the microprocessor transmits a warning signal to the fleet management unit. Alternatively, in the event of a failure in signal transmission from the compactor, the fleet management unit can send a warning signal and dispatch maintenance crews to correct the problems. Because any suspected problem can be reported immediately, the comprehensive management service system enables remedial action to be implemented promptly. Thus, the fleet management system is able to adjust and give repair instructions for each compactor that is suspected of malfunction. In the event that the fleet management unit cannot fix a problem by communication, it will issue instructions to the maintenance crews to replace the compactor. Accordingly, excellent compactor maintenance is a feature of the present invention.

The Trash Compactor Management Unit (TCMU) of the present invention contains a microprocessor system and can be connected to any waste compactor and can accept as input whatever the local standard voltage supply may be. The TCMU measures values of parameters, which enable the system to estimate weight of the contents of the waste compactor, and send such values to the Fleet Management Unit (FMU). The FMU uses a PC compatible computer. The TCMU may control the entire operation of the compactor. Therefore, every time the compactor is emptied the system is disconnected from the power supply and when reconnected, the TCMU goes through the initialization cycle. The raw or altered values generated on the TCMU are transferred from the TCMU to the FMU using a standard electronic communication system such as telephones.

Although the present invention and disclosure has been described in conjunction with trash collection, the invention is also applicable in conjunction with collecting recyclable materials such as metal cans, glass, and newspapers. Although the present invention is described in connection with particular preferred embodiments and examples, it is to be understood that many modifications and variations can be made in the process and apparatus without departing from the scope to which the inventions disclose herein are entitled. Accordingly it will be understood that these embodiments are illustrative and that the scope of the invention is not limited to them. The present invention is to be considered as including all apparatus, systems and methods encompassed by the appending claims.

What is claimed is:

1. A method for optimizing a trash pick-up schedule of a plurality of trash compactors comprising the steps of
a) measuring the weight of trash in a trash compactor unit;
b) calculating from said trash weight a targeted trash weight for pick up;
c) predicting a pick-up time based on said targeted trash weight;
d) transmitting a signal to a fleet management unit;
e) calculating a pick-up schedule for said plurality of trash compactors;
f) generating a bill containing accounting information for said trash compactor unit; and
g) generating a warning signal when said trash compactor unit malfunctions.

2. The method of claim 1 wherein said transmitting of a signal relates to a pick-up time;

3. The method of claim 2 wherein said calculating of a pick-up schedule for said trash compactors is based on the trash weight;

4. The method of claim 1 wherein said generating of a bill is based on the trash weight per compactor unit when the trash is picked up;

5. A system for optimizing trash pick-up from a plurality of trash compactor units comprising:
a. a trash compactor management unit;
b. a weight sensing device associated to said trash compactor management unit;
c. a fleet management unit;
d. a signaling device connected to said trash compactor management unit to enable said trash compactor management unit to transmit a signal to said fleet management unit;
e. means for said fleet management unit to calculate a pick-up schedule for the plurality of trash compactor units;
f. means for said fleet management unit to generate a bill for each trash compactor unit;
g. means for said fleet management unit to detect a malfunction of said trash compactor unit; and
h. means for said fleet management unit to transmit a warning signal to a fleet of trucks.

6. The system of claim 5 wherein said trash compactor unit further comprising a plurality of compactors.

7. The system of claim 5 wherein said weight sensing device is a scale.

8. The system of claim 5 wherein said trash compactor management unit is attached to said compactor.

9. The system of claim 5 wherein said trash compactor management unit further comprises a programmable micro-processor for receiving information on weight and calculating a projected time at which an estimated percentage of compactor's weight is attained.

10. The system of claim 9 wherein said estimated percentage of compactor's weight is 97100%.

11. The system of claim 5 wherein said fleet management unit further comprises a device which outputs repair hauling orders.

12. The system of claim 5 wherein said fleet management unit further comprises a device, which outputs information relating to accounting operations.

13. The system of claim 5 wherein said fleet management unit further comprises a device, which outputs information relating to trash compactor maintenance.
